(19) United States
(12) Patent Application Publication
(10) Pub. No.: US 2019/0190326 A1
(43) Pub. Date: Jun. 20, 2019

(54) STATOR, STATOR MANUFACTURING METHOD AND MOTOR

(71) Applicant: Nidec Corporation, Kyoto (JP)

(72) Inventors: Yasuaki NAKAHARA, Kyoto (JP); Takayuki MIGITA, Kyoto (JP); Hiroshi KITAGAKI, Kyoto (JP); Takeshi HONDA, Kyoto (JP); Hisashi FUJIHARA, Kyoto (JP)

(21) Appl. No.: 16/282,473

(22) Filed: Feb. 22, 2019

Related U.S. Application Data
(63) Continuation of application No. PCT/JP2017/035113, filed on Sep. 28, 2017.

(30) Foreign Application Priority Data
Sep. 30, 2016 (JP) 2016-195185

(51) Int. Cl. H02K 1/14; H02K 15/02

(52) U.S. Cl. CPC H02K 1/148; H02K 15/022

(57) ABSTRACT

A stator includes a core with an annular shape including a center that is a vertically extending central axis. The core includes core pieces in which first and second laminate members are laminated. The first laminate member includes a first tooth portion extending in a radial direction and a first core back portion extending in a circumferential direction. The first core back portion includes a first protrusion on one side thereof in the circumferential direction and a first recess on the other side thereof in the circumferential direction. The second laminate member includes a second tooth portion extending in a radial direction and a second core back portion extending in a circumferential direction. The second core back portion includes a second recess on one side thereof in the circumferential direction and a second protrusion on the other side thereof in the circumferential direction. In the first protrusion, the one side in the circumferential direction is thicker in a lamination direction than the other side in the circumferential direction, and in the second protrusion, the other side in the circumferential direction is thicker in the lamination direction than the one side in the circumferential direction.

This application claims the benefit of priority to Japanese Patent Application No. 2016-195185 filed on Sep. 30, 2016 and is a Continuation Application of PCT Application No. PCT/JP2017/035113 filed on Sep. 28, 2017. The entire contents of each application are hereby incorporated herein by reference.

### BACKGROUND OF THE INVENTION

### 1. Field of the Invention

The present disclosure relates to a stator, a stator manufacturing method, and a motor.

### 2. Description of the Related Art

A stator of a motor includes a plurality of teeth radially installed thereon, and an annular part connecting radially outer sides of the teeth in an annular shape. In the stator, an inclined part is formed on an end portion of each core piece of each divided laminate core, and pairs of core pieces with different shapes are alternately laminated with one another.

Since the stator of the conventional shape has the inclined part, it is possible to easily join the divided laminate cores adjacent to each other, while the divided laminate cores thus joined is easily detached.

### SUMMARY OF THE INVENTION

According to an exemplary embodiment of the present disclosure, a stator includes a core in an annular shape having a center that is a vertically extending central axis, and a conductive wire that is wound around the core. The core includes core pieces in which at least a first laminate member and a second laminate member are laminated. The first laminate member includes a first tooth portion extending in a radial direction and a first core back portion connected to a radially outer side of the first tooth portion and extending in a circumferential direction. The first core back portion includes a first protrusion on one side thereof in the circumferential direction and a first recess on the other side thereof in the circumferential direction. The second laminate member includes a second tooth portion extending in a radial direction and a second core back portion connected to a radially outer side of the second tooth portion and extending in a circumferential direction. The second core back portion includes a second recess on one side thereof in the circumferential direction and a second protrusion on the other side thereof in the circumferential direction. Positions of two circumferential ends of the first core back portion are different from positions of two circumferential ends of the second core back portion. In the first protrusion, the one side in the circumferential direction is thicker in a lamination direction than the other side in the circumferential direction, and in the second protrusion, the other side in the circumferential direction is thicker in the lamination direction than the one side in the circumferential direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view of a motor according to an exemplary embodiment of the present disclosure.

FIG. 2 is a plane view of a laminate member of a core piece according to an exemplary of the present disclosure.

FIG. 3 is a plane view of laminate members of laminated core pieces according to an exemplary embodiment of the present disclosure.

FIG. 4 is a plane view of annularly connected core pieces according to an exemplary embodiment of the present disclosure.

FIG. 5 is an enlarged view of a connection portion of adjacent core pieces according to an exemplary embodiment of the present disclosure.

FIG. 6 is a plane view showing an area, in which core back portions of adjacent core pieces overlap each other in a lamination direction according to an exemplary embodiment of the present disclosure.

FIG. 7 is a cross-sectional view of a connection portion of adjacent core pieces according to an exemplary embodiment of the present disclosure.

FIG. 8 is a graph showing a relationship between an average distance and a magnetic property of the area in which core back portions of adjacent core pieces overlap each other in a lamination direction according to an exemplary embodiment of the present disclosure.

FIG. 9 is a plane view of a core piece according to a modified embodiment according to an exemplary embodiment of the present disclosure.

FIG. 10 is a cross-sectional view of a connection portion of the core piece according to the modified embodiment according to an exemplary embodiment of the present disclosure.

FIG. 11 is a flowchart showing a process of manufacturing a stator according to an exemplary embodiment of the present disclosure.

FIG. 12 is a view showing a laminate member formed on a plate member used in a process of manufacturing a stator according to an exemplary embodiment of the present disclosure.

FIG. 13 is a view showing core pieces in which laminate members are laminated in the process of manufacturing a stator according to an exemplary embodiment of the present disclosure.

FIG. 14 is a view showing a divided stator having a coil formed by winding a conductive wire around teeth of a core piece in the process of manufacturing a stator according to an exemplary embodiment of the present disclosure.

### DETAILED DESCRIPTION OF THE PREFERRED EMBODIMENTS

Hereinafter, exemplary embodiments of the present disclosure will be described in detail with reference to the accompanying drawings. The exemplary embodiments described below are only exemplary examples of the present disclosure, but the technical scope is not limited thereby. Further, the same reference numerals may be assigned to the same components, and the descriptions thereof may be omitted.

The exemplary embodiments of the present disclosure relate to a configuration of a stator (referred to as a “core piece”) used in a motor and a method of manufacturing the stator. In the description, a direction parallel to a central axis of the motor and the stator is referred to as an “axial direction,” a direction orthogonal to the central axis is referred to as a “radial direction,” and a direction along an arc centered around the central axis is referred to as a “circumferential direction.” In the description, a circumferentially inner side refers to a side close to a connection portion between a core back portion and a tooth portion of a core piece, and a circumferentially outer side refers to a side distant from the connection portion between the core back portion and the tooth portion of the core piece. In the description, the term “core piece” refers to an element including a tooth portion around which a conductive wire is wound and an annularly connected core back portions. The term “core” refers to a group of a plurality of annularly connected core pieces. The term “divided stator” refers to a core piece around which the conductive wire is wound. The term “stator” refers to a group of a plurality of divided stators annularly connected. Further, each layer of the core piece, which defines the core by being laminated, refers to a “laminate member.” Further, the term “laminate member” does not indicate only a first member of members composing the core piece, but may include a plurality of members having the same or similar shapes and consecutively laminated.

Further, for convenience of description in the specification, in laminate members laminated in a manufacturing process, a direction in which the laminate members are laminated refers to an “upper side” or an “upper direction,” and a direction in which laminate members, which are already laminated, are positioned refers to a “lower side” or a “lower direction.” In most cases, the lower side opposing the upper side is positioned on a lower side in a gravity direction. Further, a direction in which the laminate members of the core piece are laminated refers to a “lamination direction.” In the following description, the lamination direction is parallel to a central axis of rotation of the motor, but the lamination direction and the central axis are not necessarily parallel to each other.

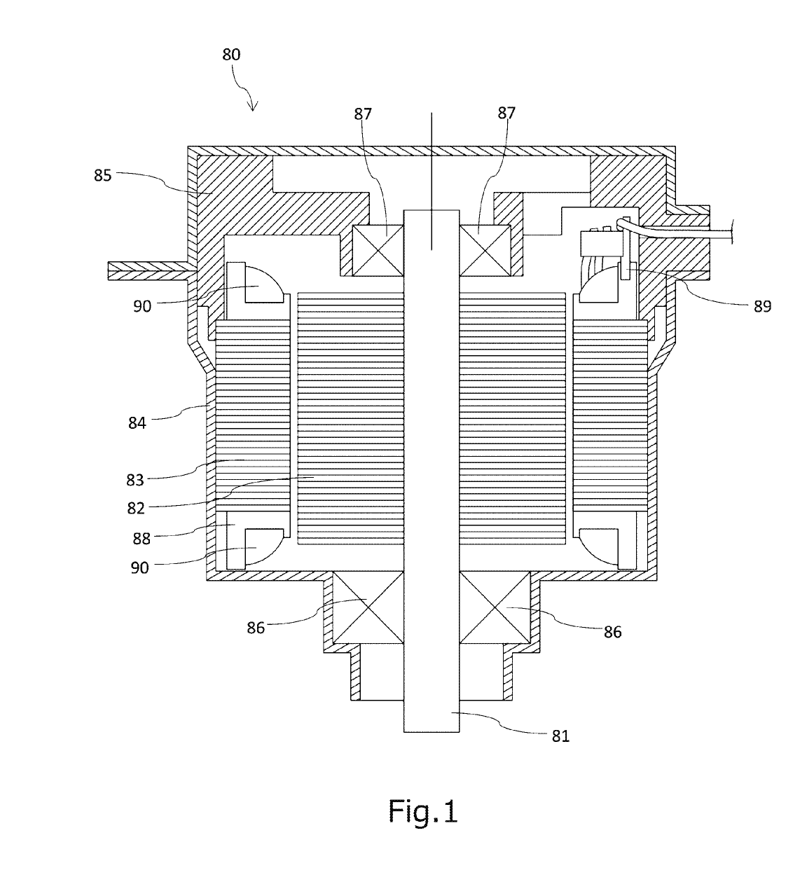

FIG. 1 is a cross-sectional view of a motor 80 of one embodiment of the present disclosure. As shown in FIG. 1, the motor 80 preferably includes a shaft 81, a rotor 82, a stator 83, a housing 84, a bearing holder 85, a first bearing 86, a second bearing 87, an insulator 88, a coil-drawing line 89, a coil 90, and the like. The shaft 81 and the rotor 82 are preferably integrated with each other by, for example, the shaft 81 being press fit through the rotor 82. The shaft 81 has a cylindrical shape having a center that is a central axis extending in one direction. The rotor 82 is positioned at a middle of the shaft 81. The rotor 82 is rotatable about the stator 83. The stator 83 is disposed to surround the rotor 82 in an axial direction. The stator 83 includes the coil 90 which is preferably by winding a conductive wire around the core of the stator 83. The housing 84 is engaged with an outer circumferential surface of the stator 83 and accommodates the shaft 81, the rotor 82, the stator 83, the bearing holder 85, the first bearing 86, the second bearing 87, the insulator 88, the coil-drawing line 89, and the coil 90 which compose the motor 80. The bearing holder 85 supports the second bearing 87. The bearing holder 85 is engaged with the housing 84. The first bearing 86 is preferably disposed at a lower portion of the housing 84 and supports one side of the shaft 81. The second bearing 87 supports the other side of the shaft 81. The insulator 88 is disposed between the stator 83 and a conductive wire of the coil 90 to insulate the stator 83 and the conductive wire of the coil 90.

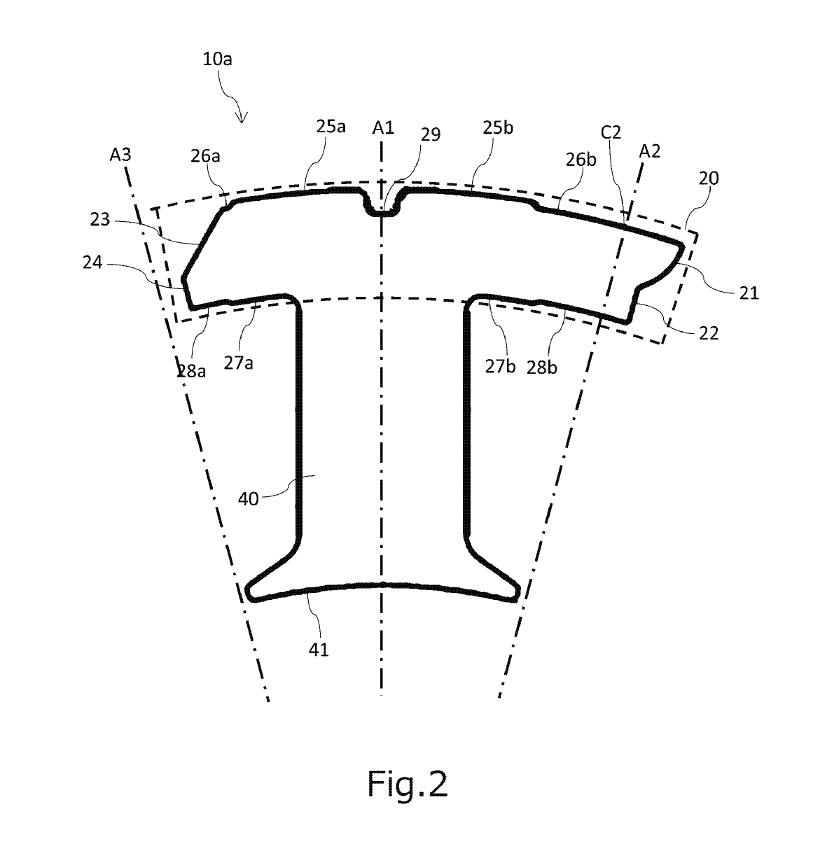

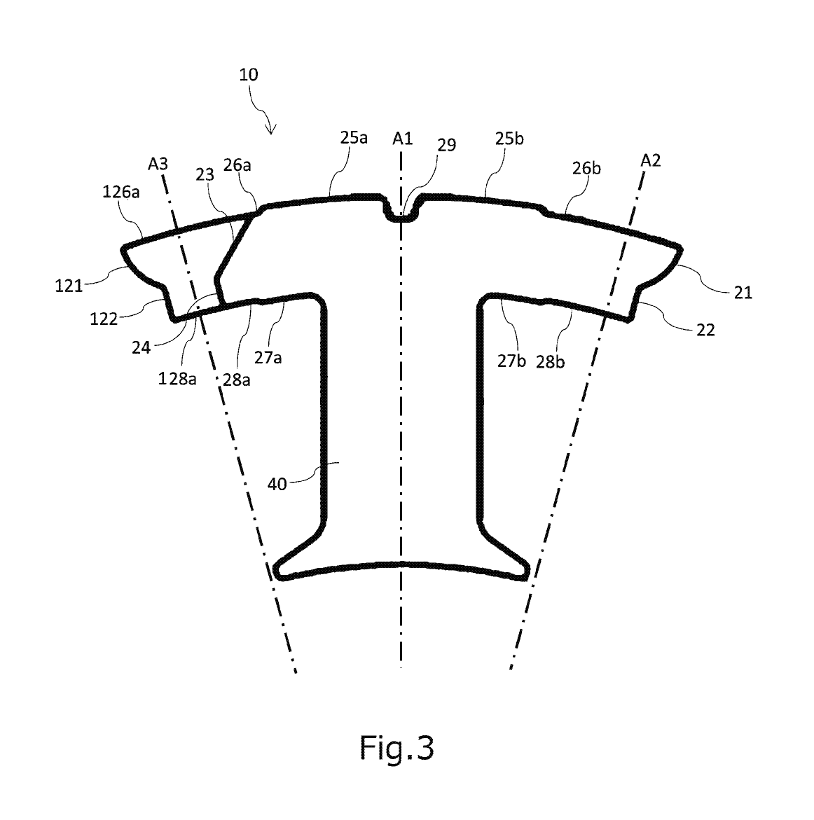

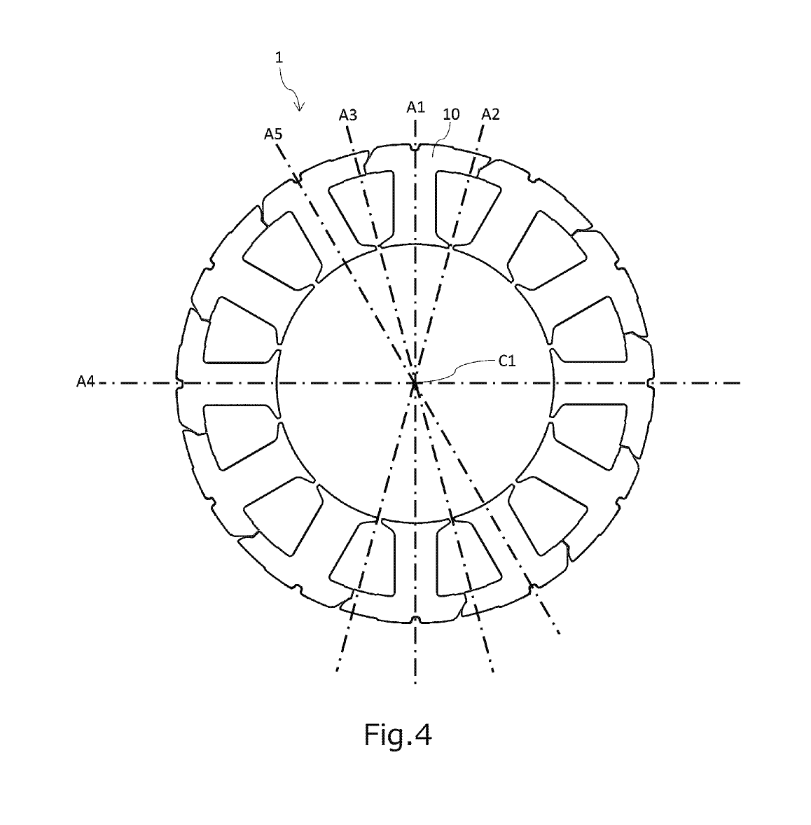

FIG. 2 is a plane view of one laminate member 10a of a core piece 10 which defines the stator 83. FIG. 3 is a plan view of the laminated core pieces 10. FIG. 4 is a plan view of a core 1 in a state in which the core pieces 10 are annularly connected.

As shown in FIG. 4, a center point of a circle of an outer circumferential surface or an inner circumferential surface defined by the core 1 is C1. Straight lines A1, A2, and A3 shown in FIGS. 2 and 3 each are lines extending in a radial direction through the center point C1. An inner angle between the straight line A1 and the straight line A2 and an inner angle between the straight line A1 and the straight line A3 are preferably about 15°, for example. An inner angle between tooth portions 40 of adjacent core pieces 10 is preferably about 30°, for example. An inner angle between the tooth portions 40 of the adjacent core pieces 10, an inner angle between the straight lines A1 and A2, and an inner angle between the straight lines A1 and A3 vary according to the number of core pieces 10 forming the core 1. The core 1 according to the present preferred embodiment of the present disclosure is preferably includes the twelve core pieces 10, and thus, as described above, each of the inner angles between the tooth portions 40 of the adjacent core pieces 10 is preferably about 30°. Further, the number of core pieces 10 composing the core 1 may be arbitrarily changed as desired.

As shown in FIG. 2, the laminate member 10a of the core piece 10 includes the tooth portion 40 and the core back portion 20. The core piece 10 is formed by laminating the plurality of laminate members 10a with a predetermined thickness. The tooth portion 40 is linearly symmetrical with respect to the straight line A1 passing through the center point C1. The tooth portion 40 has a shape in which an end on an inner side in a radial direction extends in a circumferential direction, and has an inner circumferential surface 41 on the inner side in the radial direction.

As shown in FIG. 3, one laminate member and another laminate member of the core piece 10 are laminated so that the tooth portion 40 does not protrude. Since circumferential lengths of one circumferential end of one laminate member and another circumferential end of another laminate member are different from each other, one side protrudes from another side.

The core back portion 20 is an element defining an annular portion of the core 1. The core back portion 20 is connected with a radially outer side of the tooth portion 40 and has a shape extending in a circumferential direction.

The core back portion 20 includes a circular arc-shaped protrusion 21 and a radially straight portion 22 formed at one end thereof in the circumferential direction. The radially straight portion 22 has a shape of a straight line extending in a radial direction through the center point C1. The radially straight portion 22 protrudes outward from the straight line A1 in a circumferential direction. The circular arc-shaped protrusion 21 preferably has a shape protruding circumferentially outward of a radially straight line passing through the center point C1 and the radially straight portion 22. The circular arc-shaped protrusion 21 preferably has a circular arc shape partially overlapping a circle having a center that is an intersection point C2 between the straight line A2 and an outer circumferential recess 26b of the core back portion 20. An end on a circumferential inner side of the circular arc-shaped protrusion 21 is connected with an end on the circumferential outer side of the radially straight portion 22, and the circular arc-shaped protrusion 21 and the circumferential end of the radially straight portion 22 become one circumferential end of the core back portion 20.

Further, the circular arc-shaped protrusion 21 may not necessarily have a circular arc shape if so desired. For example, the core back portion 20 may be a protrusion with an arc shape of an ellipse or a gently curved protrusion instead of the circular arc-shaped protrusion 21. But a portion corresponding to the circular arc-shaped protrusion 21 of one end of the core back portion 20 is in contact with a contact portion 23 of an adjacent core piece at one point.

The core back portion 20 includes the contact portion 23 and a radially straight portion 24 provided at the other end thereof in the circumferential direction. Like the radially straight portion 22, the radially straight portion 24 has a shape extending in a radial direction through the center point C1. Unlike the radially straight portion 22, the radially straight portion 24 has a shape of being recessed circumferentially inward of the straight line A3. The contact portion 23 preferably has a straight shape with an inclined surface recessed circumferentially inward of the radially straight portion 24. An inner angle between the radially straight portion 22 and the contact portion 23 is preferably about 135°. An end on a circumferential inner side of the contact portion 23 is connected with an end on a circumferential outer side of the radially straight portion 24, and the contact portion 23 and one circumferential end of the radially straight portion 24 become the other circumferential end of the core back portion 20.

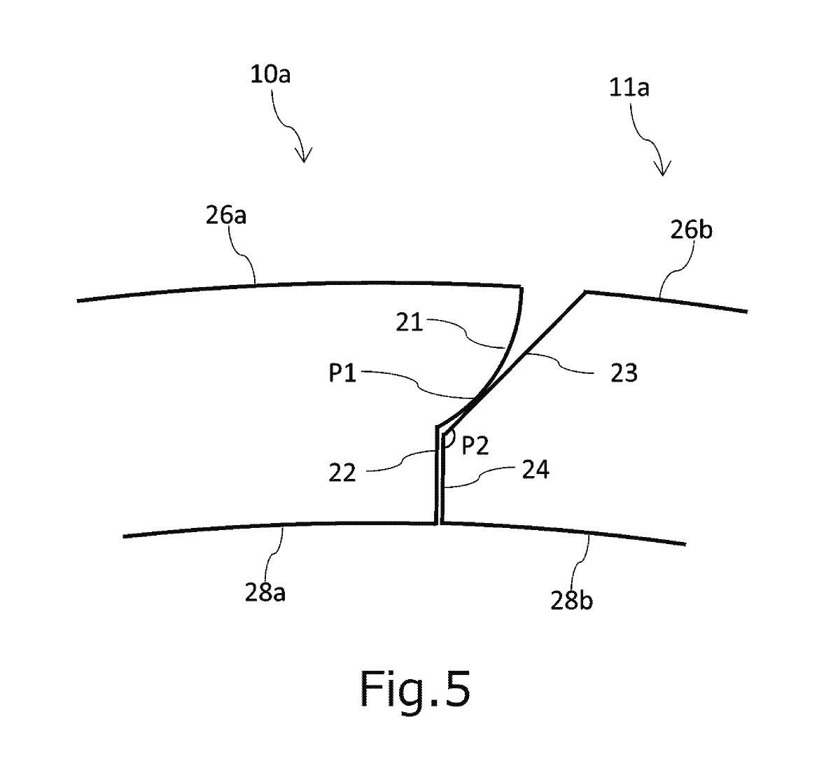

FIG. 5 is an enlarged view of a connection portion of laminate members 10a and 11a of the core pieces 10 and 11 adjacent to each other. As shown in FIG. 5, an inner angle P2 between the radially straight portion 24 and the contact portion 23 is preferably 135°.

Further, the contact portion 23 may not necessarily have a straight line shape. For example, the contact portion 23 may be a shape of a circular arc-shaped protrusion or recess or a curved portion. But a portion corresponding to the contact portion 23 of the other end of the core back portion 20 is in contact with the circular arc-shaped protrusion 21 of the adjacent core piece at one point. The contact portion 23 is also referred to as a linear recess as a representation corresponding to the circular arc-shaped protrusion. In the core back portion 20, one portion in the circumferential direction which has the circular arc-shaped protrusion 21 and the radially straight portion 22 is an example of the “protrusion” in the present disclosure. In the core back portion 20, the other portion in the circumferential direction which has the contact portion 23 and the radially straight portion 24 is an example of the “recess” of the present disclosure.

As shown in FIG. 5, one end of the laminate member 10a of the core piece 10 is preferably in contact with the other end of the laminate member 11a of the adjacent core piece 11. Specifically, the circular arc-shaped protrusion 21 of the core piece 10 and the contact portion 23 of the core piece 11 are in contact with each other at one contact point P1. The radially straight portion 22 of the core piece 10 and the radially straight portion 24 of the core piece 11 are spaced apart from each other. But the radially straight portion 22 of the core piece 10 and the radially straight portion 24 of the core piece 11 are not necessarily spaced apart from each other and may be in contact with each other.

As described above, in the core piece 10 and the core piece 11 which are adjacent to each other, the circular arc-shaped protrusion 21 of the laminate member 10a of the core piece 10 and the contact portion 23 of the laminate member 11a of the core piece 11 are in contact with each other at one point. When the core piece 10 rotates outward of the radial direction with respect to the core piece 11, the radially straight portion 22 and the radially straight portion 24 are not in contact with each other, but the circular arc-shaped protrusion 21 and the contact portion 23 are in contact with each other at one point. Even when the core piece 11 and the core piece 10 relatively rotate, the core piece 10 and the core piece 11 are in contact with each other at one point, and thus a frictional resistance between the core piece and the core piece 11 decreases. Therefore, compared to a configuration in which core pieces adjacent to each other are in surface contact with each other or in contact with each other at a plurality of points as in the conventional art, the core pieces can rotate while connected with each other.

Further, when the core piece 10 rotates with respect to the core piece 11, a center of rotation is a center C2 of a circular arc of the circular arc-shaped protrusion 21. In the laminate members of the core piece 10, since the center C2 coincides with a lamination direction, the core piece 10 may smoothly rotate about the center C2 as an axis.

Further, in the laminate members 10a and 11a of the core pieces 10 and 11, an inner angle between the radially straight portion 24 and the contact portion 23 is preferably about 135°, and thus the core piece 10 may rotate within a wide range when rotating with respect to the core piece 11 while being in contact with the core piece 11 at one point. Further, the inner angle P2 is not necessarily limited to about 135° and may be changed within a range of about 130° to about 140°. Even when the inner angle P2 is an arbitrary angle in a range of about 130° to about 140°, the core pieces can be rotated in a sufficiently wide range while being in contact with each other at one point.

An outer circumferential surface of the core back portion 20 is engaged with a housing (not shown) when a motor is assembled. The core back portion 20 includes a central recess 29, outer circumferential surfaces 25a and 25b, and outer circumferential recesses 26a and 26b provided at an outer circumferential part thereof.

The central recess 29 which is recessed inward in the radial direction is arranged at a position at which an outer circumferential surface of the core back portion 20 and the straight line A1 intersect with each other. The central recess 29 extends in a groove shape in a vertical direction in which the laminate members are laminated.

Each of the outer circumferential surfaces 25a and 25b preferably has a circular arc shape including a center that is the center point C1. The outer circumferential surfaces 25a and 25b are connected with both circumferential sides of the central recess 29. The outer circumferential surfaces 25a and 25b are portions which are in contact with the inner circumferential surface of the housing while the stator including the core 1 around which the conductive wire is wound is engaged with an inner side of the housing.

The outer circumferential recesses 26a and 26b are connected with circumferential end sides on the outer circumferential surfaces 25a and 25b. The outer circumferential recesses 26a and 26b are recessed from the outer circumferential surfaces 25a and 25b inward in a radial direction. The outer circumferential recesses 26a and 26b include a circular arc shape having a smaller diameter than that of the outer circumferential surfaces 25a and 25b and having the center point C1 the same as that of the outer circumferential surfaces 25a and 25b. When the stator is fitted to an inner side of the housing, the outer circumferential recesses 26a and 26b are not in contact with an inner circumferential surface of the housing, and thus gaps are defined between the inner circumferential surface of the housing and the outer circumferential recesses 26a and 26b.

The outer circumferential surface of the core back portion 20 of the core piece 10 is preferably engaged with the housing as a stator, as described above, the outer circumferential surfaces 25a and 25b are in contact with an inner circumferential surface of the housing, and the central recess 29 and the outer circumferential recesses 26a and 26b are not in contact with the inner circumferential surface of the housing. Therefore, accuracy of a size of the outer circumferential surface of the core back portion 20 can increase. Further, the core back portion 20 may not necessarily have the outer circumferential recesses 26a and 26b. When the core back portion 20 is formed in a shape having the outer circumferential recesses 26a and 26b, dimensions of the outer circumferential surfaces 25a and 25b more effectively increase.

The core back portion 20 preferably includes inner circumferential surfaces 27a and 27b and inner circumferential recesses 28a and 28b provided on an inner circumferential surface thereof. The inner circumferential surfaces 27a and 27b have a circular arc shape having a center that is the center point C1. The inner circumferential surfaces 27a and 27b are connected with both circumferential sides of the tooth portion 40. The inner circumferential recesses 28a and 28b are connected with circumferential end sides of the inner circumferential surfaces 27a and 27b. The inner circumferential recesses 28a and 28b are recessed from the inner circumferential surfaces 27a and 27b outward in the radial direction. The inner circumferential recesses 28a and 28b preferably include a circular arc shape having an inner diameter smaller than that of the inner circumferential surfaces 27a and 27b having the center that is the center point C1 the same or substantially the same as that of the inner circumferential surfaces 27a and 27b.

As shown in FIG. 3, when the core piece 10 including a plurality of laminate members which are laminated is viewed from above, since positions of both circumferential ends of the core back portion 20 are different from each other among the laminate members, the laminate member disposed on a lower side is partially shown. When viewed from above, a circular arc-shaped protrusion 121, a radially straight portion 122, an outer circumferential recess 126a, and an inner circumferential recess 128a of the laminate member disposed below the laminate member disposed on the top are shown at the contact portion 23, which is defined short in a circumferential direction of the core back portion 20, and a circumferential outer side of the radially straight portion 24. The circular arc-shaped protrusion 121, the radially straight portion 122, the outer circumferential recess 126a, and the inner circumferential recess 128a of the laminate members of the core piece 10 overlap an adjacent core piece in a lamination direction.

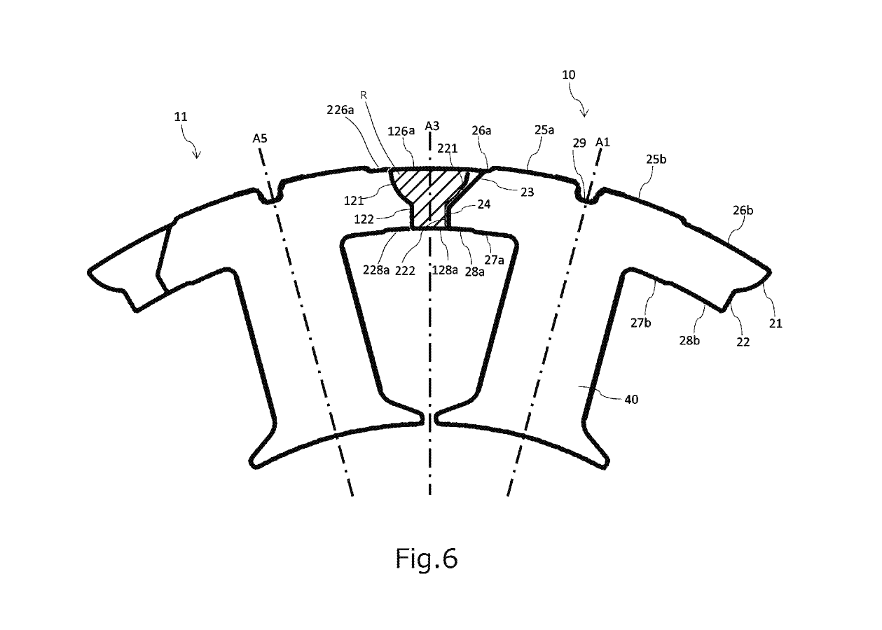

FIG. 6 is a view showing the core back portions 20 of the core pieces 10 and 11 adjacent to each other overlap each other in a lamination direction, and particularly, a view showing an overlapping area. A circular arc-shaped protrusion 221, a radially straight portion 222, an outer circumferential recess 226a, and an inner circumferential recess 228a of the laminate member of the core piece 11 are preferably laminated on the circular arc-shaped protrusion 121, the radially straight portion 122, the outer circumferential recess 126a, and the inner circumferential recess 128a of the laminate member of the core piece 10. The laminate member of the core piece 10 is disposed under the laminate member of the core piece 11. As shown in FIG. 6 with inclined lines, the core piece 10 and the core piece 11 overlap in an area R. A boundary of the area R is determined by the circular arc-shaped protrusion 221, the radially straight portion 222, the outer circumferential recess 226a, and the inner circumferential recess 228a, which are laminate members of the core piece 11 positioned on an upper side, and the circular arc-shaped protrusion 121, the radially straight portion 222, the outer circumferential recess 226a, and the inner circumferential recess 228a, which are laminate members of the core piece 10 positioned on a lower side. But the outer circumferential recess 226a and the inner circumferential recess 228a, the outer circumferential recess 226a, and the inner circumferential recess 228a preferably overlap each other in the lamination direction.

For example, an area of the area R is greater than an area of a circumferentially cross-sectional area of the core back portion 20 at a position of the straight line A3. Further, the cross-section of the core back portion 20 is calculated by multiplying a circumferential length of the core back portion 20 and a thickness of the laminate member. The reason why the area R is formed as described above is as follows.

One circumferential end of each of the laminate members of the core piece 10 is in contact with the other circumferential end of each of the laminate members of the core piece 11 at one point. For this reason, as compared with when one circumferential end of the core piece 10 is in surface contact with the other circumferential end of the core piece 11, a magnetic path is defined circumferential ends of the core pieces 10 and 11 so that an amount of magnetic flux flowing therein is narrow. Therefore, the area greater than or equal to the magnetic path which is narrowed due to the area R is able to be secured. Further, since the radially straight portion 22 and the radially straight portion are not in contact with each other in a circumferential direction in an assembled state, the magnetic path is not provided at a position at which the radially straight portion 22 and the radially straight portion 24 are not in contact with each other.

However, even in the case of adopting a configuration in which one circumferential end of each of the laminate members of the core piece 10 is not in contact, or is in surface contact, or is in contact at a plurality of points, with the other circumferential end of each of the laminate members of the core piece 11 adjacent thereto, the magnetic path is defined in the area R, and thus the magnetic property is improved. Here, the magnetic property is an amount of the magnetic flux flowing through a portion where an uneven part of an end of the core piece 10 and an uneven part of an end of the core piece 11 are engaged with each other.

Further, it is preferable that the area R be less than or equal to about 5 times the circumferential cross-sectional area of the core back portion 20. Therefore, an area in which the core back portions 20 of the adjacent core piece 10 overlap in the lamination direction is sufficiently secured, and thus a sufficient magnetic path is able to be secured. Further, because a frictional resistance is prevented from being excessively generated in the lamination direction of the core back portion 20 of the adjacent core piece 10, the adjacent core pieces are able to rotate in a manufacturing process.

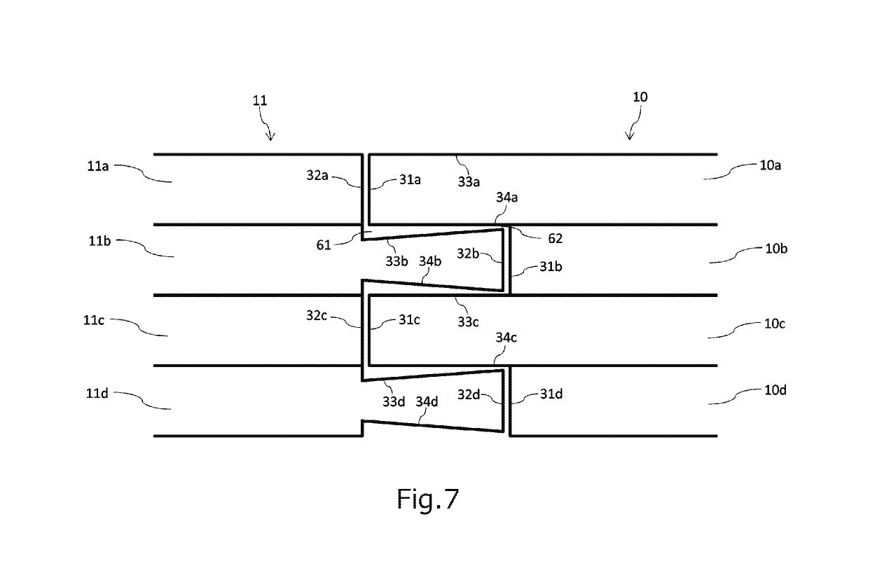

FIG. 7 is a cross-sectional view of the connection portion of the core pieces 10 and 11 adjacent to each other. As shown in FIG. 7, the core piece 10 is preferably defined by laminate members 10a to 10d which are laminated. The core piece 11 is preferably defined by laminate members 11a to 11d which are laminated. Ends of the core piece 10 and the core piece 11 face each other and have uneven parts. Ends of the laminate members 10a and 10c and the laminate members 11b and 11d are protrusions, and ends of the laminate members 10b and 10d and the laminate members 11a and 11c are recesses. Uneven parts of the end of the core piece 10 and uneven parts of the end of the core piece 11 are engaged with each other to connect the core pieces 10 and 11.

Ends 31a to 31d are provided at circumferential ends of the laminate members 10a to 10d of the core piece 10, respectively. The ends 31a and 31c are ends of the circular arc-shaped protrusions 21 or the radially straight portions 22. The ends 31b and 31d are ends of the contact portion 23s or the radially straight portions 24. On the other hand, ends 32a to 32d are provided at circumferential ends of the laminate members 11a to 11d of the core piece 11, respectively. The ends 32a to 32d face the ends 31a to 31d, respectively. The ends 32b and 32d are ends of the circular arc-shaped protrusions 21 or the radially straight portions 22. The ends 31b and 31d are ends of the contact portions 23 or the radially straight portions 24. As shown in FIG. 7, a gap 61 at a portion on the circumferentially inner side of the end 32b is wider than a gap 62 at a portion on the circumferentially outer side of the end 32b. The ends 32b and 32d are formed to be thicker in the lamination direction from the circumferentially inner side toward the circumferentially outer side. In other words, thicknesses of the ends 32b and 32d increase in the laminating direction from the circumferentially inner side toward the circumferentially outer side.

More specifically, upper surfaces 33b and 33d of the ends 32b and 32d are inclined upward toward the circumferentially outer side. Lower surfaces 34b and 34d of the ends 32b and 32d are inclined downward toward the circumferentially outer side. A lower surface 34a faces the upper surface 33b, an upper surface 33c faces the lower surface 34b, and a lower surface 34c faces the upper surface 33d. Each of an upper surface 33a, the lower surface 34a, the upper surface 33c, and the lower surface 34c extends in a straight shape toward the circumferentially outer side without inclination. In this manner, in a portion where the core back portions 20 of the adjacent core pieces 10 and 11 are laminated, a distance in the lamination direction varies depending on its circumferential position.

As described above, the end of the circular arc-shaped protrusion 21 or the radially straight portion 22 has a shape in which its thickness in the lamination direction increases in the circumferential direction, that is, a circumferentially outwardly thickening shape. In the core pieces connected to each other, it is possible to fix adjacent core pieces to each other and it is possible to prevent them from becoming detached. Especially, as in the manufacturing method which will be described later, in the case of adopting a manufacturing method in which lamination progresses as adjacent core pieces are laminated to overlap each other, it is particularly effective because the connection between the adjacent core pieces is not released.

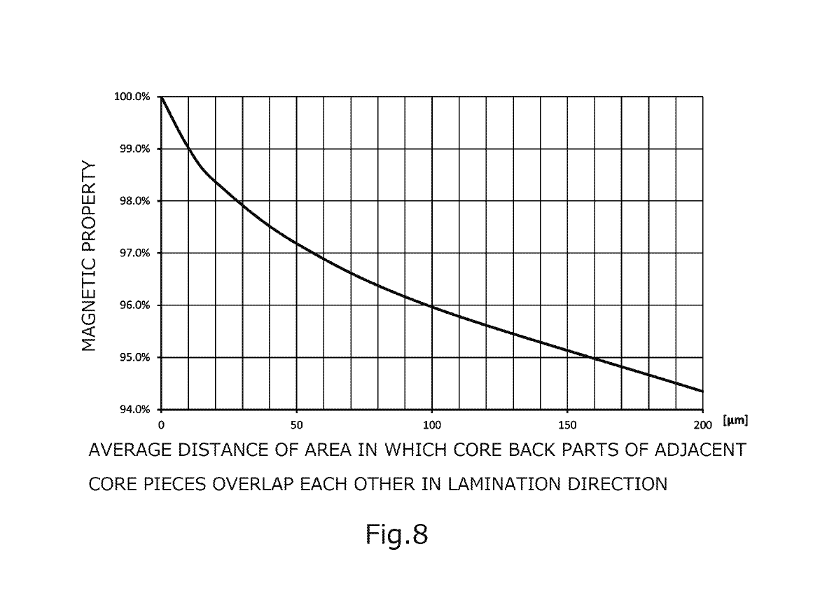

FIG. 8 is a diagram showing a result of calculating the relationship between an average distance of a region where the core back portions 20 of the adjacent core pieces overlap in the lamination direction and a magnetic property in a motor, using software for magnetic analysis. The region where the core back portions 20 of the adjacent core pieces overlap in the lamination direction is indicated as a region from the gap 61 to the gap 62 in FIG. 7. The horizontal axis of the graph of FIG. 8 represents the average distance in the region where the core back portions 20 of the adjacent core pieces overlap each other. The vertical axis of the graph of FIG. 8 represents a magnetic property relative to the case where a magnetic property in a motor using a stator in a state in which the core back portions 20 of the adjacent core pieces are in contact with each other in the entire region where they overlap in the lamination direction is taken as 100%. As shown in FIG. 8, when the magnetic property in the motor using the stator in the state in which the core back portions 20 of the adjacent core pieces are in contact with each other in the entire region where they overlap in the lamination direction is taken as 100%, the magnetic property of the motor decreases as the average distance of the region where the core back portions 20 overlap in the lamination direction becomes larger.

For example, as shown in FIG. 8, the magnetic property in the motor using the stator in which the average distance of the region where the core back portions 20 of the adjacent core pieces overlap each other in the lamination direction is 10 μm is about 99% as compared with the magnetic property in the motor using the stator in which the core back portions 20 of the adjacent core pieces are in contact with each other in the entire region where they overlap in the lamination direction. Also, the magnetic property in the motor using the stator in which the average distance of the region where the core back portions 20 of the adjacent core pieces overlap each other in the lamination direction is 20 μm is about 98% as compared with the magnetic property in the motor using the stator in which the core back portions 20 of the adjacent core pieces are in contact with each other in the entire region where they overlap in the lamination direction. Also, the magnetic property in the motor using the stator in which the average distance of the region where the core back portions 20 of the adjacent core pieces overlap each other in the lamination direction is 50 μm is about 97% as compared with the magnetic property in the motor using the stator in which the core back portions 20 of the adjacent core pieces are in contact with each other in the entire region where they overlap in the lamination direction.

Therefore, if the average distance of the region where the adjacent core pieces overlap each other in the lamination direction is set to 50 μm or less, it is possible to suppress the deterioration of the magnetic property at the time of driving the motor using the stator to about 3%. Also, if the average distance of the region where the adjacent core pieces overlap each other in the lamination direction is set to 20 μm or less, it is possible to suppress the deterioration of the magnetic property at the time of driving the motor using the stator to about 2%. Also, if the average distance of the region where the adjacent core pieces overlap each other in the lamination direction is set to 10 μm or less, it is possible to suppress the deterioration of the magnetic property at the time of driving the motor using the stator to about 1%. In addition, it is preferable to select the average distance of the region where the adjacent core pieces overlap each other in the lamination direction depending on a specification of a motor to be manufactured, required simplicity of a manufacturing process, or the like. For example, in the case of increasing the magnetic property of a motor, the average distance is set to 10 μm, and in the case of reducing contact resistance in order to facilitate rotation of core pieces in a conductive wire winding process in a manufacturing method of a motor which will be described later, the average distance is set to 50 μm.

Further, the upper surface 33b and the lower surface 34b of the end 32b and the upper surface 33d and the lower surface 34d of the end 32d are not necessarily inclined, and may have a shape in which thicknesses are different on one side and the other side thereof in the circumferential direction. For example, the upper surface 33b and the lower surface 34b of the end portion 32b, and the upper surface 33d and the lower surface 34d of the end portion 34d may have a shape in which steps are formed intermittently so that the thickness of the core back portion 20 changes.

Furthermore, the ends 31a and 31c may also be formed to be larger in the lamination direction from the circumferentially inner side toward the circumferentially outer side. With this configuration, the distance in the lamination direction also varies depending on a circumferential position in the portion where the core back portions 20 of the adjacent core pieces 10 and 11 are laminated. In addition, this configuration also makes it possible to connect adjacent core pieces 10 and 11 more strongly.

A stator, a core, and a core piece of the present disclosure are not limited to the above-described preferred embodiment, and various forms made based on the preferred embodiment may be included. For example, the stator, the core, and the core piece of the present disclosure may be elements including the modified preferred embodiments described below. Further, the same elements as those in the above-described preferred embodiment will be designated with the same name or numeral references, and the description thereof may be omitted.

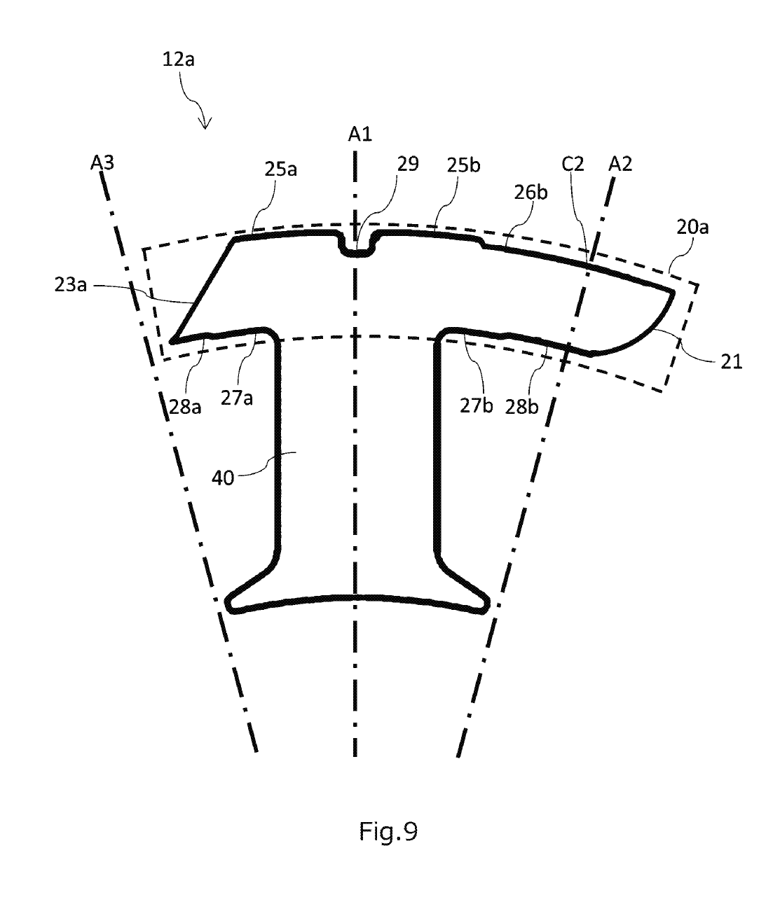

FIG. 9 is a plan view of laminate members 12a defining a core piece 12 as a modified preferred embodiment according to the present disclosure. As shown in FIG. 9, the shapes of both circumferential ends of the laminate member 12a of the modification are different from those of the laminate member 10a (see FIG. 2) according to the above-describe preferred embodiment of the present disclosure.

Specifically, the laminate member 12a has a circular arc-shaped protrusion 21a provided at one circumferential end of the core back portion 20a thereof. The laminate members 12a preferably include a contact portion 23a formed at the other circumferential end of the core back portion 20a. The laminate member 12a of the modification does not have radially straight portions formed at both ends thereof.

Even in the case of this configuration, ends in a circumferential direction of the adjacent core pieces are in contact with each other at one point, and the same effect as that of the above-described embodiment is obtained. The core piece 12 of the modification is used, and thus the laminate members of the core piece are able to be easily manufactured.

However, as described in the above-described embodiment, when the laminate member includes the radially straight paths 22 and 24, and one core piece is rotated in a direction in which an inner side in the radial direction gets close to the other core piece, the radially straight paths 22 and 24 come into contact with each other. Therefore, one core piece is able to be prevented from rotating in a direction in which the radially inner side gets close to the other core piece.

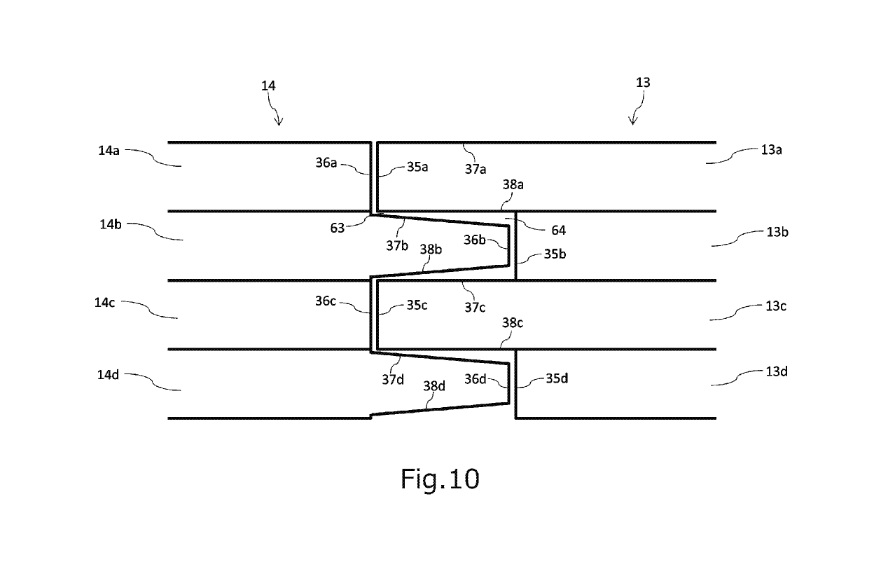

FIG. 10 is a cross-sectional view of a connection portion of core pieces 13 and 14 in a modified preferred embodiment according to the present disclosure. As shown in FIG. 10, the core pieces 13 and 14 of the present modified preferred embodiment are defined by laminating laminate members 13a to 13d and 14a to 14d, respectively. Ends of the core piece 13 and the core piece 14 are opposed to each other, and uneven parts are defined thereon. The laminate members 13a to 13d include ends 35a to 35d in the circumferential direction. The laminate members 14a to 14d have ends 36a to 36d in the circumferential direction.

Compared to the core pieces 10 and 11 in the embodiment shown in FIG. 7, the core pieces 13 and 14 of present modified preferred embodiment are different in that the ends 36b and 36d get thinned in the lamination direction from the circumferentially inner side toward the circumferentially outer side. In other words, the thicknesses of the ends 36b and 36d in the lamination direction decrease from the circumferentially inner side toward the circumferentially outer side. As shown in FIG. 10, a gap 63 at a portion on the circumferentially inner side of the end 36b is narrower than a gap 64 at a portion on the circumferentially outer side. The ends 36b and 36d correspond to the ends 32b and 32d in the preferred embodiment, respectively.

More specifically, upper surfaces 37b and 37d of the ends 36b and 36d are inclined downward toward the circumferentially outer side. Lower surfaces 38b and 38d of the ends 36b and 36d are inclined upward toward the circumferentially outer side. A lower surface 38a faces the upper surface 37b, an upper surface 37c faces the lower surface 38b, and a lower surface 38c faces the upper surface 37d. Each of the upper surface 37a, the lower surface 38a, the upper surface 37c, and the lower surface 38c extends in a straight shape toward the circumferentially outer side without inclination. In this way, a distance in the lamination direction varies depending on a position in the circumferential direction in a portion where the core back portions 20 of the adjacent core pieces 13 and 14 are laminated.

As described above, the ends of the circular arc-shaped protrusion 21 or the radially straight portion 22 have a shape in which the thickness in the lamination direction decreases in the circumferential direction, that is, a circumferentially outwardly tapered or substantially circumferentially outwardly tapered shape. When separated core pieces are connected to each other, the core pieces can be easily connected to each other.

In the stator of the present modified preferred embodiment, similarly to the preferred embodiment, the average distance and the magnetic property of the region where the core back portions 20 of the adjacent core pieces overlap in the lamination direction have a relationship as shown in FIG. 8. That is, when the magnetic property in the motor using the stator in the state in which the core back portions 20 of the adjacent core pieces are in contact with each other in the entire region where they overlap in the lamination direction is taken as 100%, the magnetic property of the motor decreases as the average distance of the region where the core back portions 20 overlap in the lamination direction becomes larger. Therefore, in the stator of the present modified preferred embodiment, it is preferable in view of the magnetic property that the average distance of the region where the adjacent core pieces overlap each other in the lamination direction be 50 μm or less similarly to the stator of the preferred embodiment. Also, it is more preferable in view of the magnetic property that the average distance of the region where the adjacent core pieces overlap each other in the lamination direction be 20 μm or less. Also, in the stator of the present modified preferred embodiment, it is even more preferable in view of the magnetic property that the average distance of the region where the adjacent core pieces overlap each other in the lamination direction be 10 μm or less. However, it is preferable to select the average distance of the region where the adjacent core pieces overlap each other in the lamination direction depending on a specification of a motor to be manufactured, required simplicity of a manufacturing process, or the like. For example, in the case of increasing the magnetic property of a motor, the average distance is set to 10 μm, and in the case of reducing contact resistance in order to facilitate rotation of core pieces in a conductive wire winding process in a manufacturing method of a motor which will be described later, the average distance is set to 50 μm.

Further, the upper surface 37b and the lower surface 38b of the end 36b and the upper surface 37d and the lower surface 38d of the end 36d are not necessarily inclined, and may have a shape in which thicknesses are different on one side and the other side thereof in the circumferential direction.

Furthermore, the ends 35a and 35c may also be defined to be smaller in the lamination direction from the circumferentially inner side toward the circumferentially outer side. With this configuration, the distance in the lamination direction also varies depending on a circumferential position in the portion where the core back portions 20 of the adjacent core pieces 13 and 14 are laminated.

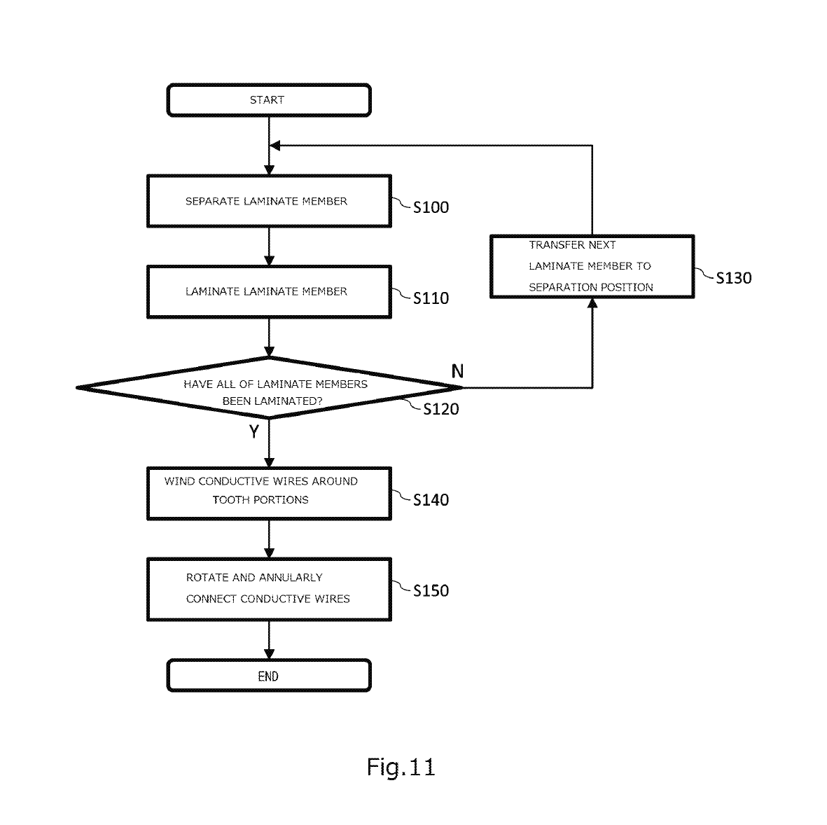

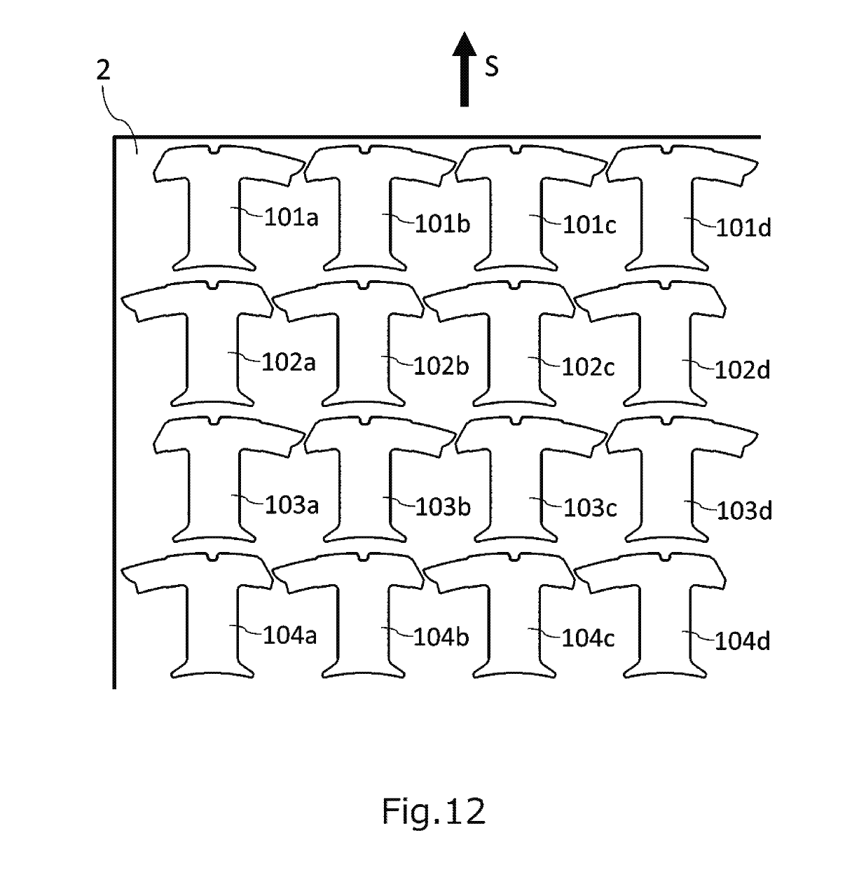

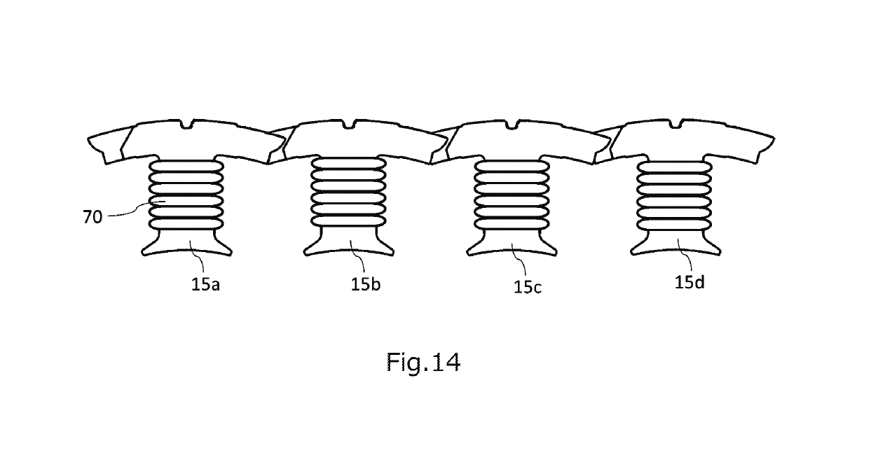

A method of manufacturing a stator of an exemplary embodiment of the present disclosure will be described with referent to FIGS. 11 to 14. Further, although a plurality of the stacked laminate plate members are arranged in a circumferential direction, to form of annularly connected cores in practice, only a portion of them are shown in FIGS. 12 to 14, and the others are omitted for the sake of simplicity. Hereinafter, in a plane which is horizontal to a gravity direction, a direction horizontal to a transfer direction of the plate member refers to a “transverse direction.”

FIG. 11 is a flowchart showing a process of manufacturing a stator according to an exemplary embodiment of the present disclosure. In the process of manufacturing the stator, a process of separating a laminate member from a plate member, which is a base material, (S100) is performed first. When the laminate member is separated, the separated laminate member is laminated on the laminate member (S110).

FIG. 12 is a view showing laminate members 101a, 101b, 101c, 101d, 102a, 102b, 102c, 102d, 103a, 103b, 103c, 103d, 104a, 104b, 104c, and 104d of core pieces provided on a plate member 2. The laminate members 101a 101b, 101c, and 104d are arranged in each lamination layer. The laminate members 101a 101b, 101c, and 104d are arranged in a first layer, the laminate members 102a, 102b, 102c, and 102d are arranged in a second layer, the laminate members 103a, 103b, 103c, and 103d are arranged in a third layer, and the laminate members 104a, 104b, 104c, and 104d are arranged in a fourth layer, and thus the core piece is formed. In the process of separating the laminate members, the laminate members in the same layer are simultaneously or sequentially separated.

When all of the laminate members are not laminated (N of S120), the plate member 2 is transferred in a transfer direction S (see FIG. 12), then the laminate members to be laminated are transferred to a separation position (S130). For example, before separation of the laminate members 102a, 102b, 102c, and 102d in the second layer is performed, the laminate members 102a, 102b, 102c, and 102d formed on the plate member 2 are positioned right above the separated laminate members 101a, 101b, 101c, and 104d in the first layer. Further, a separation of the laminate members 102a, 102b, 102c, and 102d is performed (S100) so that the laminate members 102a, 102b, 102c, and 102d are laminated on the laminate members 101a to 104d.

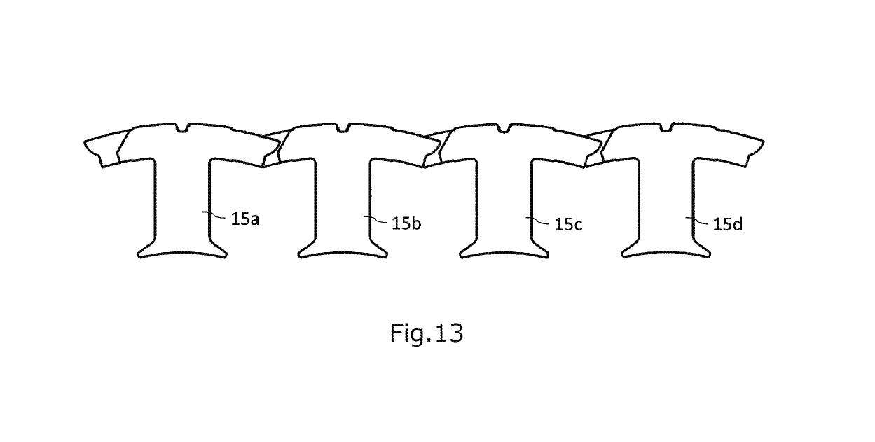

FIG. 13 is a view showing core pieces in which laminate members are laminated in a process of manufacturing a stator. When all of the laminate members are laminated (Y of S120), as shown in FIG. 13, core pieces 15a, 15b, 15c, and 15d in which the laminate members are laminated are arranged in a transverse direction. In this state, conductive wires are wound around tooth portions 40 of the core pieces 15a, 15b, 15c, and 15d, and thus a coil 70 is formed (S140). When the conductive wires are wound around the tooth portions 40 of the core pieces 15a, 15b, 15c, and 15d, the core pieces 15a, 15b, 15c, and 15d may be rotated in a direction in which tooth portions 40 of the adjacent core pieces are spaced apart from each other, and thus a wide space provided around the tooth portions 40 allows the conductive wires to be easily wound around the tooth portion 40. In this case, the circular arc-shaped protrusion 21 and the contact portion 23 of the adjacent core pieces are in contact with each other at one point, and the core pieces are rotated about a center C2 while changing a contact position. FIG. 13 is a view showing divided stators on which a coil 70 is formed by winding a conductive wire around tooth portions 40 of core pieces 15a, 15b, 15c, and 15d. When the conductive wires are wound around the tooth portions 40, the divided stators of the core pieces 15a to 15d around which the conductive wires are wound are rotated, and the core back portions 20 are annularly connected (S150). Thus, the stator having the core 1, on which the conductive wire is wound, shown in FIG. 4 is formed.

If a stator using the core pieces of the embodiment as shown in FIG. 7 is adopted, even when the divided stator of the core pieces 15a, 15b, 15c, and 15d around which the conductive wires are wound is rotated as described above, it is possible to smoothly rotate the divided stator while preventing release of the connection between the core pieces.

Further, the plate member 2 used in a manufacturing configuration may not be necessarily one plate member but may be two or more plate members if so desired.

The present disclosure may be used as, for example, a stator for a motor.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A stator comprising:
a core with an annular shape and including a center that is a vertically extending central axis; and
a conductive wire that is wound around the core; wherein
the core includes core pieces in which at least a first laminate member and a second laminate member are laminated;
the first laminate member includes a first tooth portion extending in a radial direction and a first core back portion connected to a radially outer side of the first tooth portion and extending in a circumferential direction;
the first core back portion includes a first protrusion on one side thereof in the circumferential direction and a first recess on the other side thereof in the circumferential direction;
the second laminate member includes a second tooth portion extending in a radial direction and a second core back portion connected to a radially outer side of the second tooth portion and extending in a circumferential direction;
the second core back portion includes a second recess on one side thereof in the circumferential direction and a second protrusion on the other side thereof in the circumferential direction;
positions of two circumferential ends of the first core back portion are different from positions of two circumferential ends of the second core back portion;
in the first protrusion, the one side in the circumferential direction is thicker in a lamination direction than the other side in the circumferential direction; and
in the second protrusion, the other side in the circumferential direction is thicker in the lamination direction than the one side in the circumferential direction.

2. The stator according to claim 1, wherein
an average distance in the lamination direction between the first core back portion and the second core back portion of a core piece adjacent thereto is about 50 μm or less; and
an average distance in the lamination direction between the second core back portion and the first core back portion of a core piece adjacent thereto is about 50 μm or less.

3. The stator according to claim 1, wherein each of the first protrusion and the second protrusion includes a circular arc shape portion.

4. The stator according to claim 3, wherein
the first protrusion includes a circular arc shape including a center that is a position at which a bisector between a radially center line of the first tooth portion and a center line in a radial direction of a first tooth portion of the core piece adjacent thereto intersects with an outer circumferential surface of the first core back portion; and
the second protrusion has a circular arc shape including a center that is a position at which a bisector between a radially center line of the second tooth portion and a center line in a radial direction of a second tooth portion of the core piece adjacent thereto intersects with an outer circumferential surface of the second core back portion.

5. The stator according to claim 1, wherein
the first protrusion is in contact with a core piece adjacent thereto at one point; and
the second protrusion is in contact with a core piece adjacent thereto at one point.

6. The stator according to claim 5, wherein
the first core back portion further includes a first contact portion at one side thereof in the circumferential direction;
the second core back portion further includes a second contact portion at one side thereof in the circumferential direction;
the first protrusion is in contact with the first contact portion adjacent thereto at one point; and
the second protrusion is in contact with the second contact portion adjacent thereto at one point.

7. The stator according to claim 6, wherein each of the first contact portion and the second contact portion has a straight shape.

8. The stator according to claim 7, wherein
the first core back portion includes a first radially straight portion extending in the radial direction on one side thereof in the circumferential direction, and a second radially straight portion extending in the radial direction on the other side thereof in the circumferential direction; and
the second core back portion includes a third radially straight portion extending in the radial direction on one side thereof in the circumferential direction, and a fourth radially straight portion extending in the radial direction on the other side thereof in the circumferential direction.

9. The stator according to claim 8, wherein the first contact portion includes an inclined surface having an inclination of greater than or equal to about 130 degrees and less than or equal to about 140 degrees with respect to the first radially straight portion.

10. The stator according to claim 1, wherein an area of a region where the first core back portion and the second core back portion of the core piece adjacent thereto overlap in the lamination direction is greater than a circumferential cross-sectional area of the first core back portion on a circumferentially inner side with respect to the first protrusion.

11. A motor comprising the stator according to claim 1.

12. A stator comprising:
a core with an annular shape and including a center that is a vertically extending central axis; and
a conductive wire that is wound around the core; wherein
the core includes core pieces in which at least a first laminate member and a second laminate member are laminated;
the first laminate member includes a first tooth portion extending in a radial direction and a first core back portion connected to a radially outer side of the first tooth portion and extending in a circumferential direction;
the first core back portion includes a first protrusion on one side thereof in the circumferential direction and a first recess on the other side thereof in the circumferential direction;
the second laminate member includes a second tooth portion extending in a radial direction and a second core back portion connected to a radially outer side of the second tooth portion and extending in a circumferential direction;
the second core back portion includes a second recess on one side thereof in the circumferential direction and a second protrusion on the other side thereof in the circumferential direction;
positions of two circumferential ends of the first core back portion are different from positions of two circumferential ends of the second core back portion;
in the first protrusion and the second protrusion, the one side in the circumferential direction is different in thickness from the other side in the circumferential direction;
an average distance in the lamination direction between the first core back portion and the second core back portion of a core piece adjacent thereto is about 50 μm or less; and
an average distance in the lamination direction between the second core back portion and the first core back portion of a core piece adjacent thereto is about 50 μm or less.

13. The stator according to claim 12, wherein
the average distance in the lamination direction between the first core back portion and the second core back portion of the core piece adjacent thereto is about 20 μm or less; and
the average distance in the lamination direction between the second core back portion and the first core back portion of the core piece adjacent thereto is about 20 μm or less.

14. The stator according to claim 12, wherein
the average distance in the lamination direction between the first core back portion and the second core back portion of the core piece adjacent thereto is about 10 μm or less; and
the average distance in the lamination direction between the second core back portion and the first core back portion of the core piece adjacent thereto is about 10 μm or less.

15. The stator according to claim 12, wherein each of the first protrusion and the second protrusion has a circular arc shape.

16. The stator according to claim 15, wherein
the first protrusion has a circular arc shape including a center that is a position at which a bisector between a radially center line of the first tooth portion and a center line in a radial direction of a first tooth portion of the core piece adjacent thereto intersects with an outer circumferential surface of the first core back portion; and
the second protrusion has a circular arc shape including a center that is a position at which a bisector between a radially center line of the second tooth portion and a center line in a radial direction of a second tooth portion of the core piece adjacent thereto intersects with an outer circumferential surface of the second core back portion.

17. The stator according to claim 12, wherein
the first protrusion is in contact with a core piece adjacent thereto at one point; and
the second protrusion is in contact with a core piece adjacent thereto at one point.

18. The stator according to claim 17, wherein
the first core back portion further includes a first contact portion at one side thereof in the circumferential direction;
the second core back portion further includes a second contact portion at one side thereof in the circumferential direction;
the first protrusion is in contact with the first contact portion adjacent thereto at one point; and
the second protrusion is in contact with the second contact portion adjacent thereto at one point.

19. The stator according to claim 18, wherein each of the first contact portion and the second contact portion has a straight shape.

20. The stator according to claim 19, wherein
the first core back portion includes a first radially straight portion extending in the radial direction on one side thereof in the circumferential direction, and a second radially straight portion extending in the radial direction on the other side thereof in the circumferential direction; and
the second core back portion includes a third radially straight portion extending in the radial direction on one side thereof in the circumferential direction, and a fourth radially straight portion extending in the radial direction on the other side thereof in the circumferential direction.

21. The stator according to claim 20, wherein the first contact portion includes an inclined surface having an inclination of greater than or equal to about 130 degrees and less than or equal to about 140 degrees with respect to the first radially straight portion.

22. The stator according to claim 12, wherein an area of a region where the first core back portion and the second core back portion of the core piece adjacent thereto overlap in the lamination direction is greater than a circumferential cross-sectional area of the first core back portion on a circumferentially inner side with respect to the first protrusion.

23. A motor comprising the stator according to claim 12.

24. A method of manufacturing a stator including a core with an annular shape and including a center that is a vertically extending central axis and a conductive wire that is wound around the core, the method comprising:
separating a plurality of first laminate members disposed in parallel or substantially in parallel in a first direction from a plate member;
separating a plurality of second laminate members disposed in parallel or substantially in parallel in the first direction from the plate member and laminating the plurality of second laminate members on the plurality of first laminate members so that a first tooth portion and a second tooth portion overlap each other;
winding a conductive wire around teeth including the first tooth portion and the second tooth portion overlapping each other; and
connecting divided stators, which are disposed in parallel or substantially in parallel in the first direction and around which the conductive wire is wound, in an annular shape by rotating the divided stators; wherein
the core includes core pieces in which at least the first laminate member and second laminate member are laminated;
in each of the core pieces:
the first laminate member of the core piece includes a first tooth portion extending in a radial direction, and a first core back portion connected to a radially outer side of the first tooth portion and extending in a circumferential direction;
the first core back portion includes a first protrusion on one side thereof in the circumferential direction and a first recess on the other side thereof in the circumferential direction;
the second laminate member includes a second tooth portion extending in a radial direction and a second core back portion connected to a radially outer side of the second tooth portion and extending in a circumferential direction;
the second core back portion includes a second recess on one side thereof in the circumferential direction and a second protrusion on the other side thereof in the circumferential direction;
positions of two circumferential ends of the first core back portion are different from positions of two circumferential ends of the second core back portion;
the first protrusion has a shape that thickens in the lamination direction toward one side thereof in the circumferential direction; and
the second protrusion has a shape that thickens in the lamination direction toward the other side thereof in the circumferential direction.
